(19) United States
(12) Patent Application Publication
(10) Pub. No.: US 2026/0268124 A1
(43) Pub. Date: Sep. 10, 2026

(54) SELF-ENHANCED TEST-TIME SCALING OF GENERATIVE NEURAL NETWORKS

(71) Applicant: Google LLC, Mountain View, CA (US)

(72) Inventors: Jiefeng Chen, San Jose, CA (US); Jie Ren, San Jose, CA (US); Sercan Omer Arik, San Francisco, CA (US); Xinyun Chen, Saratoga, CA (US); Chengrun Yang, Sunnyvale, CA (US); Ruoxi Sun, Mountain View, CA (US)

(21) Appl. No.: 19/075,613

(22) Filed: Mar. 10, 2025

(51) Int. Cl. G06N 3/0475

(52) U.S. Cl. CPC G06N 3/0475

(57) ABSTRACT

Methods, systems, and apparatus, including computer programs encoded on a computer storage medium, for generating output sequences in response to requests. One of the methods includes receiving a request for an output sequence; generating a plurality of candidate output sequences in parallel with each other; selecting, from the plurality of candidate output sequences, a selected candidate output sequence; and providing the selected candidate output sequence in response to the request.

### BACKGROUND

This specification relates to implementing neural networks to generate output sequences. For example, the output sequences can include text sequences, audio sequences, pixel sequences (that represent an image or a video frame), and so on.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes an inference system implemented as computer programs on one or more computers in one or more locations that implements a neural network to perform one or more generative tasks.

Particular embodiments of the subject matter described in this specification can be implemented so as to realize one or more of the following advantages. Leveraging the self-verification and self-adjustment capabilities of the generative neural networks, the techniques described in this specification improve the efficiency of inference-time compute scaling for generative neural networks.

That is, the described techniques increase the likelihood that a higher quality output sequence, e.g., an output sequence that is more pertinent to the request, more informative, or that has greater veracity or utility, can be provided by the inference system in response to a given prompt, as the amount of computational resources, including processor usage and memory usage, that are consumed when generating the output sequences at inference time increases. From another point of view, the improved efficiency of inference-time compute scaling makes possible a reduction in computational resource consumption compared to a known inference system which performs the same generative task with the same accuracy.

For example, the described techniques outperform conventional approaches such as repeated sampling with majority voting or reward model scoring, which exhibit diminishing returns, achieving up to 8.7% accuracy improvement on the NATURAL PLAN benchmark and LiveBench Reasoning benchmark with the same generative neural network. The capability to generate higher quality output sequences improves the performance of the inference system on a range of generative tasks that require complex planning and reasoning processes.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example inference system.

FIG. 2 is a flow diagram of an example process for generating an output sequence.

FIG. 3 shows an example of operations performed by an inference system to generate an output sequence.

Like reference numbers and designations in the various drawings indicate like elements.

### DETAILED DESCRIPTION

This specification describes an inference system 100 implemented as computer programs on one or more computers in one or more locations that implements a generative neural network 110 to perform one or more generative tasks, i.e., to generate output sequences 122 for the generative tasks in response to received requests.

In some implementations, the inference system 100 obtains an input sequence 102 as part of or in association with a request and generates an output sequence 122 based on the input sequence 102. For example, the inference system 100 can receive (at least a part of) the input sequence 102 together with the request in a single user input or multiple user inputs. As another example, the inference system 100 can retrieve (at least a part of) the input sequence 102 from a local or remote data storage accessible by the inference system.

The generative neural network 110 is a neural network that has parameters and that has been configured through training to process an input sequence 102 that is made up of tokens from a vocabulary in accordance with the parameters to generate, based on the input sequence 102, an output sequence 122 for a generative task that is made up of tokens from the vocabulary. For example, the input sequence 102 can include a prompt that provides context for the output sequence 122.

The vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code.

Additionally, or alternatively, the vocabulary of tokens can include tokens that can represent data other than text. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

In some implementations, the generative neural network 110 can be configured as an auto-regressive language model or multi-modal neural network. The language model (or multi-modal) neural network is referred to as an auto-regressive neural network when the language model (or multi-modal) neural network auto-regressively generates an output sequence of tokens by generating each particular token in the output sequence conditioned on a current input sequence that includes any (e.g. all) tokens that precede the particular token in the output sequence, i.e., tokens that have already been generated for any previous positions in the output sequence that precede the particular position of the particular token, and the input sequence.

For example, the current input sequence when generating a token at any given position in the output sequence can include the input sequence and the tokens at any preceding positions that precede the given position in the output sequence. As a particular example, the current input sequence can include the input sequence followed by the tokens at any (e.g. all) preceding positions that precede the given position in the output sequence. Optionally, the input sequence and the current output sequence can be separated by one or more predetermined tokens within the current input sequence.

More specifically, to generate a particular token at a particular position within an output sequence, the generative neural network 110 can process the current input sequence to generate a score distribution, e.g., a probability distribution, that assigns a respective score, e.g., a respective probability, to each token in the vocabulary of tokens. The generative neural network 110 can then select, as the particular token, a token from the vocabulary using the score distribution. For example, the generative neural network 110 can greedily select the highest-scoring token or can sample, e.g., using nucleus sampling or another sampling technique, a token from the distribution.

As a particular example, the generative neural network 110 can be or include an auto-regressive Transformer-based neural network that includes (i) a stack of attention layers that each apply a self-attention operation and (ii) an output subnetwork that processes an output of the last attention layer to generate the score distribution.

In this example, the generative neural network 110 in this example can have any of a variety of Transformer-based language model neural network architectures. Examples of such neural network architectures include those described in Colin Raffel, et al., Exploring the limits of transfer learning with a unified text-to-text transformer. arXiv preprint arXiv:1910.10683, 2019; Daniel Adiwardana, et al., Towards a human-like open-domain chatbot. CoRR, abs/2001.09977, 2020; Tom B Brown, et al., Language models are few-shot learners. arXiv preprint arXiv:2005.14165, 2020; Aakanksha Chowdhery, et al., PaLM: Scaling Language Modeling with Pathways, arXiv preprint arXiv:2204.02311; Rohan Anil, et al., Palm 2 technical report. arXiv preprint arXiv:2305.10403, 2023; Gemini Team, et al., Gemini: a family of highly capable multimodal models. arXiv preprint arXiv:2312.11805 (2023); and Gemini. Team, P, et al., Gemini 1.5: Unlocking multimodal understanding across millions of tokens of context. arXiv preprint arXiv:2403.05530 (2024).

Some examples of generative tasks that the inference system 100 can be configured to perform follow.

As an example, the generative neural network can generate text sequences, i.e., each output sequence generated by the generative neural network is a sequence of text tokens from a vocabulary of text tokens that includes, e.g., one or more of characters, sub-words, words, punctuation marks, numbers, or other symbols that appear in natural language text. For example, the inference system can use the generative neural network to generate text sequences and provide the text sequences for presentation to users.

As another example, the generative neural network can generate images or videos that have multiple frames (where each frame is an image) by generating images, e.g., either as sequences of pixels or through an iterative denoising process. For example, the output sequence generated by the generative neural network includes a plurality of color values for pixels in an image arranged according to a specified order. As another example, the output sequence generated by the generative neural network includes a plurality of tokens that represent image patch embeddings of an image which can then be processed by a decoder neural network to generate the image. For example, the inference system can use the generative neural network to generate an image or a video conditioned on an input sequence that includes a text description of the content of the image or the video.

As another example, the input sequence is a sequence of text and the output sequence is another sequence of text, e.g., a completion of the input sequence of text, a paraphrase of the input sequence of text, a response to a question posed in the input sequence, or a sequence of text that is about a topic specified by the input sequence of text. As another example, the input sequence can be an input other than text, e.g., a plurality of pixels included in an image, and the output sequence can be a text sequence that describes the input.

As another example, the input sequence represents data to be compressed, e.g., image data, text data, audio data, or any other type of data; and the output sequence is a compressed version of the data. The tokens included in the output sequence can include any representation of compressed data, e.g., symbols or embeddings to be decoded by a respective neural network.

As a particular example, the inference system can be part of a dialog system and the input sequence can include audio or text from the most recent conversational turn submitted by a user of the dialog system during the dialog while the output sequence is the next turn in the conversation, e.g., either text or audio that is a response to the most recent conversational turn. Optionally, the input sequence can also include one or more historical conversational turns that occurred earlier in the conversation.

As another particular example, the inference system can be part of a machine translation system and the input sequence can include text in a source language while the output sequence can include text in a target language that is a translation of the source text into the target language.

As another particular example, the inference system can be part of a natural language processing system. For example, if the input sequence is a sequence of words in an original language, e.g., a sentence or phrase, the output sequence can be a summary of the input sequence in the original language, i.e., a sequence that has fewer words than the input sequence but that retains the essential meaning of the input sequence. As another example, if the input sequence is a sequence of words that form a question, the output sequence can be a sequence of words that form an answer to the question.

As another particular example, the inference system can be part of a computer-assisted medical diagnosis system. For example, the input sequence can be a sequence of data from an electronic medical record and the output sequences can each be a sequence of predicted treatments.

As another particular example, the inference system can be part of a computer code generation system and the input sequence can include a text description of a desired piece of code or a snippet of computer code in a programming language and the output sequence can include computer code, e.g., a snippet of code that is described by the input sequence or a snippet of code that follows the input sequence in a computer program.

As another particular example, the inference system can be part of a multi-modal system that processes multi-modal input sequences, e.g., both text and image input sequences, or both text and audio input sequences, and generates the output sequences that are either in a single data modality or in multiple data modalities, e.g., text and image output sequences, or text and audio output sequences. Examples of such multi-modal systems include an image captioning system, a text-based image search system, an image-based question answering system, and so on.

As another particular example, the inference system can be part of or associated with a robotic control system, i.e., a system for controlling one or more mechanical agents. The input sequence can comprise a natural language description of one or more tasks for a the one or more mechanical agents and the output sequence can comprise a sequence of instructions (e.g., joint angles, torques, velocities, etc.) for the one or more mechanical agents that cause the one or more mechanical agents to perform the one or more tasks described in the input sequence.

In a similar example, the inference system can be part of or associated with a control system in a manufacturing environment for manufacturing a product, i.e., a system for controlling a manufacturing unit or a machine that operates to manufacture the product. In another similar example, the inference system can be part of or associated with a control system in a service facility comprising a plurality of items of electronic equipment.

As another particular example, the inference system can be part of or associated with a search system that facilitates searching of resources on the Internet. A resource can be any data that can be provided over the Internet. A resource can be identified by a resource address that is associated with the resource. Resources include web pages, word processing documents, portable document format (PDF) documents, images, video, and news feed sources, to name a few.

In this particular example, the search system can receive search queries submitted by user devices and, in response, identify resources that are relevant to the search query in the form of search results and return the search results to the user devices in search results pages. A search result page can include search result data generated by the search system that identifies a resource responsive to a search query, and includes a link to the resource. The search result page can additionally include a result in the form of an output sequence that is generated by the inference system based on an input sequence derived from the search query.

Prior to deployment at the inference system 100, the generative neural network 110 can have been trained using a two-stage approach: a pre-training stage followed by a fine-tuning stage.

In the pre-training stage, the generative neural network 110 is trained by the inference system 100 or another training system based on optimizing one or more unsupervised or self-supervised objective functions, e.g., a maximum-likelihood objective function, on one or more large datasets. The one or more large datasets used during the pre-training stage can include a large dataset of text in one or more natural languages, e.g., text that is publicly available from the Internet or another text corpus, a large dataset of computer code in one or more programming languages, e.g., Python, C++, C#, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

In the fine-tuning stage, the generative neural network 110 is adjusted by the inference system 100 or another training system to one or more specific generative tasks, which can include any combination of one or more of the generative tasks mentioned below and possibly other tasks, through fine-tuning adaptation based on supervised learning, reinforcement learning from human feedback (RLHF), reinforcement learning from AI feedback (RLAIF), prompt tuning, instruction tuning, and the like, that use different training objectives, different datasets, or both.

At inference time, the inference system 100 receives a request for an output sequence 122 and, in response, uses the generative neural network 110 that operates in tandem with a self-enhanced sampling engine 120 to execute multiple data processing pipelines to generate multiple candidate output sequences based on the input sequence 102. In some implementations, the inference system 100 executes the multiple data processing pipelines in parallel with each other to reduce overall processing time needed to execute the multiple data processing pipelines.

Each data processing pipeline includes an initial sampling step and one or more iterations of a self-verification step and, in some cases, one or more iterations of a self-adjustment step.

At the initial sampling step, the self-enhanced sampling engine 120 can use the same generative neural network 110 to generate multiple different initial candidate output sequences based on the same request, e.g., by using beam search decoding from score distributions generated by the generative neural network 110, using a Sample-and-Rank decoding strategy, or using another decoding strategy that leverages the auto-regressive nature of the generative neural network, the randomness in the generation process, or both.

At the self-verification step, the self-enhanced sampling engine 120 leverages the generative neural network 110 to determine whether an initial candidate output sequence satisfies the set of one or more output sequence criteria. If the initial candidate output sequence satisfies all of the output sequence criteria in the set of one or more output sequence criteria, then the data processing pipeline stops. Alternatively, if the initial candidate output sequence fails to satisfy at least one output sequence criterion in the set of one or more output sequence criteria, then the self-adjustment step is performed.

At the self-adjustment step, the self-enhanced sampling engine 120 similarly leverages the generative neural network 110 to modify the initial candidate output sequence to generate an adjusted candidate output sequence. After the self-adjustment step, another self-verification step can be performed to determine whether the adjusted candidate output sequence satisfies the one or more output sequence criteria. The data processing pipeline continues in this way.

The set of one or more output sequence criteria can include any of a variety of criteria that measure properties that are relevant to the quality of a given candidate output sequence in terms of the generative task that the inference system 100 is configured to perform.

For example, the set of one or more output sequence criteria can include a criterion that corresponds to the sensibleness of the output sequence. The sensibleness criterion measures whether the model's responses are sensible, i.e., whether a given candidate output sequence generated by the generative neural network 110 makes sense in the context of the current interaction, i.e., as a response to the input sequence, and does not contradict any information in the input sequence or in earlier input sequences during the current interaction, e.g., any constraints defined in the input sequence. Thus, an output sequence satisfies this criterion if the output sequence is sensible, and does not violate any constraints defined in the input sequence.

As another example, the set of one or more output sequence criteria can include a criterion that corresponds to the specificity of the output sequence. The specificity criterion measures whether the model's responses are specific, i.e., whether a given candidate output sequence generated by the generative neural network 110 is specific to the corresponding input sequence 102 as opposed to being a generic response that could apply to any of variety of input sequences.

As another example, the set of one or more output sequence criteria can include a criterion that corresponds to the interestingness of the output sequence. The interestingness criterion measures whether the model's responses are interesting, i.e., whether a given candidate output sequence generated by the generative neural network 110 would be interesting to a human that provided the corresponding input sequence 102.

Other criteria can be included instead of or in addition to the above criteria. For example, the other criteria can include a suitability criterion that measures the degree to which a given output sequence is suitable for being provided in response to the request.

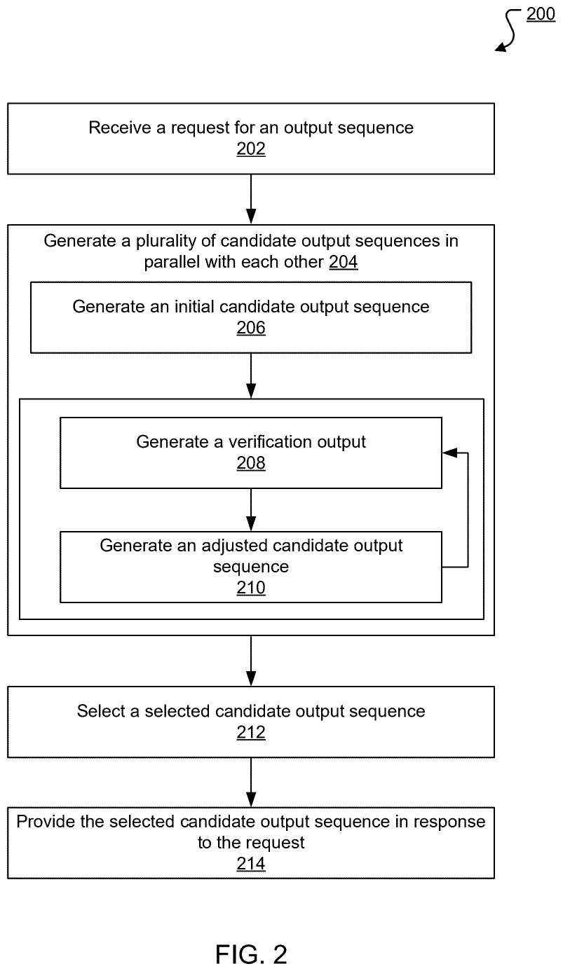

Having executed the multiple data processing pipelines in this manner to generate the multiple candidate output sequences, the inference system 100 then determines which of the multiple candidate output sequences to provide as the output sequence 122 in response to the request. There are many ways in which the inference system 100 can determine how to respond to a given request, i.e., to determine which candidate output sequence to provide in response to the request. A few examples will be discussed below with reference to FIG. 2

Once the inference system 100 has selected the candidate output sequence, the inference system 100 provides the selected candidate output sequence as the output sequence 122 in response to the request. Optionally, in some implementations, the inference system 100 can store the output sequence 122 in a data storage, or provide the output sequence 122 to another system for further processing.

For example, the inference system 100 can provide the output sequence 122 for presentation in a user interface that is presented on a display of a user device, e.g., the user device through which the user submitted the request.

As another example, in some implementations where the inference system 100 is implemented as part of or in communication with a digital assistant device, e.g., a mobile device, a smartwatch or other wearable device, or a smart speaker device, the digital assistant device can provide the output sequence 122 to the user, e.g., by generating speech representing the output sequence 122 and playing back the speech to the user over a speaker.

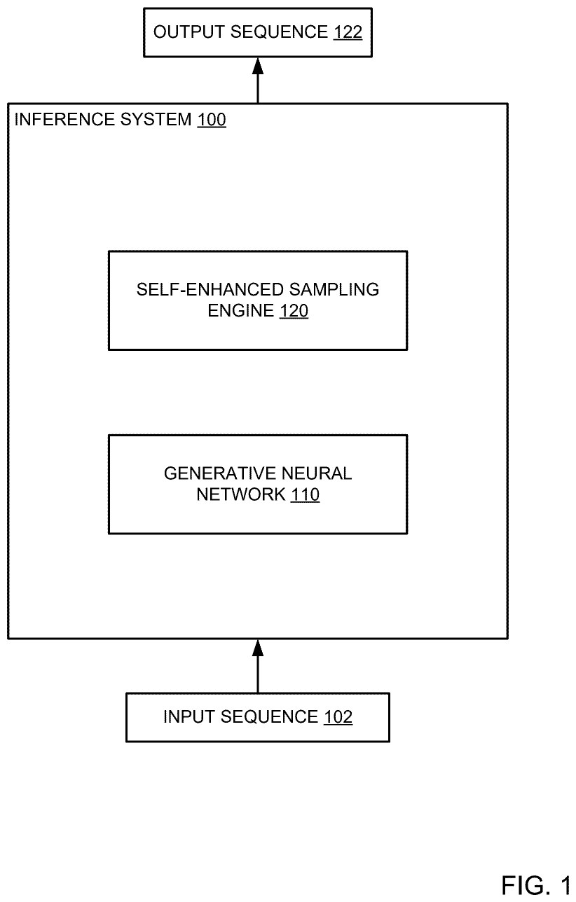

FIG. 2 is a flow diagram of an example process 200 for generating an output sequence. For convenience, the process 200 will be described as being performed by a system of one or more computers located in one or more locations. For example, an inference system, e.g., the inference system 100 depicted in FIG. 1, appropriately programmed in accordance with this specification, can perform the process 200.

The system receives a request for an output sequence (step 202). In some implementations, the system obtains an input sequence as part of or in association with the request. For example, the input sequence can include a prompt that provides context for the output sequence.

The system generates a plurality of candidate output sequences in parallel with and, in some implementations, independently of one another (step 204). In this way, the generation time of one of the plurality of candidate output sequences overlaps with the generation time of another one of the plurality of candidate output sequences.

In some implementations, the generation of the plurality of candidate output sequences can be performed by the system in parallel across different hardware devices in order to reduce latency and increase computational efficiency. For example, each candidate output sequence can be generated on a respective set of one or more hardware devices across a group of hardware devices that operate independently and substantially in parallel.

Throughout this specification, a “hardware device” may be, e.g., a computer, a core within a computer having multiple cores, or other hardware or software, e.g., a dedicated thread, within a computer capable of independently perform operations. The hardware devices may include processor cores, processors, microprocessors, special-purpose logic circuitry, e.g., an FPGA (field-programmable gate array) or an ASIC (application-specific integrated circuit), or any other appropriate hardware devices. In some examples, the hardware devices are all the same type of hardware device. In other examples, the hardware devices may be different types of hardware devices. For example, one hardware device may be a CPU while other hardware devices may be GPUs.

As part of step 204, the system performs step 206 and one or more iterations of step 208 and, in some cases, one or more iterations of step 210 to generate each candidate output sequence. For each candidate output sequence, the system can perform step 206 and one or more iterations of steps 208 and 210 in parallel with performing step 206 and one or more iterations of steps 208 and 210 for another candidate output sequence.

The system generates, using a generative neural network, an initial candidate output sequence (step 206). Step 206 corresponds to the initial sampling step of the data processing pipeline mentioned above. The initial candidate output sequence includes a plurality of tokens that are each selected from a vocabulary of tokens. The initial candidate output sequence can be one of the multiple initial candidate output sequences that are generated in parallel by using the generative neural network based on the input sequence.

The system processes, using the generative neural network, a verification input that includes (i) a current candidate output sequence, (ii) the input sequence, and (iii) a set of one or more verification instructions that is represented as text in some natural language, to generate a verification output that specifies whether the current candidate output sequence satisfies a set of one or more output sequence criteria (step 208). By providing the set of one or more verification instructions to the generative neural network, the system causes the generative neural network to generate the verification output. Step 208 corresponds to the self-verification step of the data processing pipeline mentioned above.

At the first iteration of step 208, the current candidate output sequence is the initial candidate output sequence generated by using the generative neural network in step 206. At any subsequent iteration of step 208, the current candidate output sequence is the adjusted candidate output sequence generated in the immediately preceding iteration of step 210.

In some implementations, the verification output includes text in some natural language that specifies whether the current candidate output sequence satisfies the set of one or more output sequence criteria. In some of these implementations, in cases where the current candidate output sequence fails to satisfy the set of one or more output sequence criteria, the verification output additionally includes text that identifies which criteria is not satisfied by the current candidate output sequence.

In some other implementations, the verification output includes a numeric value, e.g., a binary value (e.g., true or false) of whether the current candidate output sequence satisfies the set of one or more output sequence criteria, or a confidence value (e.g., between 0 and 1) that represents a likelihood that the current candidate output sequence satisfies the set of one or more output sequence criteria.

In response to determining, from the verification output, that the current candidate output sequence satisfies the set of one or more output sequence criteria, an iteration of step 210 will not be performed, and the system uses the current candidate output sequence as the candidate output sequence.

Alternatively, in response to determining, from the verification output, that the current candidate output sequence fails to satisfy the set of one or more output sequence criteria, the system updates the current candidate output sequence by processing, using the generative neural network, an adjustment input that includes (i) the current candidate output sequence, (ii) the verification output, and (iii) a set of one or more adjustment instructions that is represented as text in some natural language, to generate an adjusted candidate output sequence (step 210). By providing the set of one or more adjustment instructions to the generative neural network, the system causes the generative neural network to generate the adjusted candidate output sequence. Step 210 corresponds to the self-adjustment step of the data processing pipeline mentioned above.

The adjusted candidate output sequence is a modified, e.g., improved, version of the current candidate output sequence. In this way, the system uses the same generative neural network both to evaluate the initial candidate output sequences, and to modify the initial candidate output sequences to generate the adjusted candidate output sequences.

After step 210, another iteration of step 208 is performed. That is, the system uses the generative neural network to generate another verification output that specifies whether the adjusted candidate output sequence satisfies the set of one or more output sequence criteria.

In response to determining, from the other verification output, that the adjusted candidate output sequence satisfies the set of one or more output sequence criteria, another iteration of step 210 will not be performed, and the system uses the adjusted candidate output sequence as the candidate output sequence.

Alternatively, in response to determining, from the other verification output, that the current candidate output sequence still fails to satisfy the set of one or more output sequence criteria, the system performs another iteration of step 210 to use the generative neural network to generate another adjusted candidate output sequence. Then, a further iteration of step 208 can be performed following the other iteration of step 210.

In this way, the system generates each candidate output sequence by repeatedly performing one or more iterations of step 208 and, in some cases, one or more iterations of step 210, until termination criteria for the data processing pipeline have been satisfied, e.g., until the set of one or more output sequence criteria are satisfied, until a threshold number of iterations of the of step 208 and/or step 210 have been performed, or until a threshold amount of wall clock time has elapsed.

The system selects, from the plurality of candidate output sequence, a selected candidate output sequence (step 212). This selection can be made in any of a variety of ways.

In some implementations, the system can randomly select, as the selected candidate output sequence, a candidate output sequence from the plurality of candidate output sequences, or can use to a deterministic selection algorithm to select, as the selected candidate output sequence, a candidate output sequence from the plurality of candidate output sequences.

In some implementations, the system can process each of the plurality of candidate output sequences using the generative neural network to generate one or more discrimination outputs that specify which candidate output sequence in the plurality of candidate output sequences should be selected. That is, the system uses the same generative neural network both to generate the candidate output sequences, and to “discriminate” between the generated candidate output sequences to determine which candidate output sequence should be selected.

In some implementations, the system can process each of the plurality of candidate output sequences using a reward model to generate a reward score for the of candidate output sequence and then select, as the selected candidate output sequence, a candidate output sequence from the plurality of candidate output sequences that has the highest reward score. The reward model can be any machine learning model, e.g., any neural network, that has been configured through training to process an output sequence to generate a reward score for the output sequence that measures one or more properties of the output sequence.

The system provides the selected candidate output sequence in response to the request (step 214).

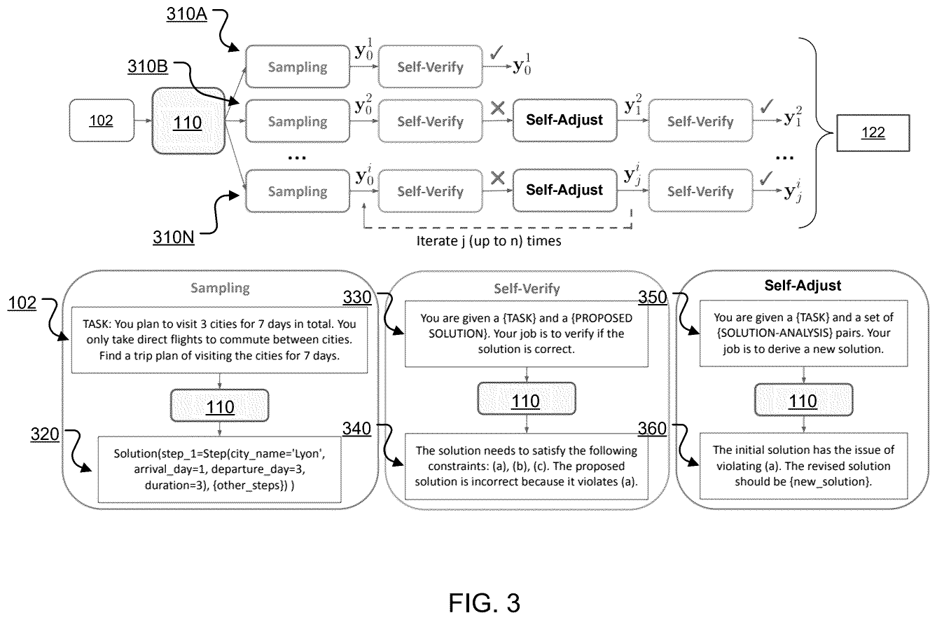

FIG. 3 shows an example of operations performed by the inference system 100 to generate an output sequence based on executing multiple data processing pipelines, e.g., data processing pipeline 310A, data processing pipeline 310B, through data processing pipeline 310N, in parallel to generate multiple candidate output sequences by using the generative neural network 110 based on the input sequence 102.

At the initial sampling step of the data processing pipeline 310A, the inference system 100 generates an initial first candidate output sequence

$${y}_{0}^{1}$$

using the generative neural network 110 based on the input sequence 102.

At the self-verification step of the data processing pipeline 310A, the inference system 100 processes a first verification input that includes (i) the initial first candidate output sequence, (ii) the input sequence 102, and (iii) the set of one or more verification instructions using the generative neural network 110 to generate a first verification output that specifies whether the initial first candidate output sequence

$${y}_{0}^{1}$$

satisfies the set of one or more output sequence criteria.

In the example of FIG. 3, since the inference system 100 determines, from the first verification output, that the initial first candidate output sequence

$${y}_{0}^{1}$$

satisfies the set of one or more output sequence criteria, the data processing pipeline 310A stops. That is, no self-adjustment step will be performed, and the inference system 100 uses the initial first candidate output sequence

$${y}_{0}^{1}$$

as a candidate output sequence that has been generated by the data processing pipeline 310A without updating the initial first candidate output sequence

$${y}_{0}^{1} .$$

In parallel with the data processing pipeline 310A, the inference system 100 executes the data processing pipeline 310B. At the initial sampling step of the data processing pipeline 310B, the inference system 100 generates an initial second candidate output sequence

$${y}_{0}^{2}$$

(320) using the same generative neural network 110 based on the same input sequence 102.

At the self-verification step of the data processing pipeline 310B, the inference system 100 processes a second verification input that includes (i) the initial second candidate output sequence

$${y}_{0}^{2}$$

(320), (ii) the input sequence 102, and (iii) the set of one or more verification instructions 330 using the generative neural network 110 to generate a second verification output 340 that specifies whether the initial second candidate output sequence

$${y}_{0}^{2}$$

(320) satisfies the set of one or more output sequence criteria.

In the example of FIG. 3, since the inference system 100 determines, from the second verification output, that the initial second candidate output sequence

$${y}_{0}^{2}$$

(320) fails to satisfy the set of one or more output sequence criteria, the data processing pipeline 310B continues.

At the self-adjustment step of the data processing pipeline 310B, the inference system 100 processes an adjustment input that includes (i) the initial second candidate output sequence

$${y}_{0}^{2}$$

(320) and (ii) the second verification output 340, and (iii) the set of one or more adjustment instructions 350 using the generative neural network 110 to generate an adjusted second candidate output sequence

$${y}_{1}^{2}$$

(360). The data processing pipeline 310B continues.

At another self-verification step of the data processing pipeline 310B, the inference system 100 processes a second verification input that includes (i) the adjusted second candidate output sequence, (ii) the input sequence 102, and (iii) the set of one or more verification instructions using the generative neural network 110 to generate another second verification output that specifies whether the adjusted second candidate output sequence

$${y}_{1}^{2}$$

satisfies the set of one or more output sequence criteria.

Since the inference system 100 determines, from the other second verification output, that the adjusted second candidate output sequence

$${y}_{1}^{2}$$

satisfies the set of one or more output sequence criteria, the data processing pipeline 310B stops. That is, another self-adjustment step will not be performed, and the inference system 100 uses the adjusted second candidate output sequence

$${y}_{1}^{2}$$

as a candidate output sequence that has been generated by the data processing pipeline 310B.

Each data processing pipeline can continue until termination criteria for the data processing pipeline have been satisfied, e.g., until the set of one or more output sequence criteria are satisfied, until a threshold number of iterations of the self-verification step and/or the self-adjustment have been performed, or until a threshold amount of wall clock time has elapsed.

Thus, other data processing pipelines, e.g., data processing pipeline 310N, being executed by the inference system 100 in parallel with the data processing pipelines 310A, 310B might involve multiple iterations of the self-verification step and multiple iterations of the self-adjustment step.

In the cases where multiple iterations of the self-adjustment step are performed in a data processing pipeline, the adjustment input to be processed by using the generative neural network 110 for a subsequent iteration of the self-adjustment step can include (i) the current candidate output sequence that has been processed in each preceding iteration of the self-adjustment step and (ii) the verification output that has been generated in each preceding iteration of the self-adjustment step, and (iii) the set of one or more adjustment instructions. In this way the adjustment input encodes more information about the history of the data processing pipeline.

Having executed the multiple data processing pipelines in this manner to generate the multiple candidate output sequences, the inference system 100 then selects one of the multiple candidate output sequences to provide as the output sequence 122 in response to the request.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, wherein the method comprises:
receiving a request for an output sequence;
generating a plurality of candidate output sequences in parallel with each other, the generating comprising, for each of the plurality of candidate output sequences:
generating, using a generative neural network, an initial candidate output sequence;
performing the following operations until one or more output sequence criteria are satisfied, wherein the operations comprise:
processing, using the generative neural network, a verification input comprising a current candidate output sequence to generate a verification output that specifies whether the current candidate output sequence satisfies the one or more output sequence criteria; and
in response to determining from the verification output that the current candidate output sequence fails to satisfy the one or more output sequence criteria, updating the current candidate output sequence by processing, using the generative neural network, an adjustment input comprising (i) the current candidate output sequence and (ii) the verification output to generate an adjusted candidate output sequence;
selecting, from the plurality of candidate output sequences, a selected candidate output sequence; and
providing the selected candidate output sequence in response to the request.

2. The method of claim 1, wherein the generative neural network comprises a language model neural network or a multi-modal neural network.

3. The method of claim 1, wherein each candidate output sequence comprises a plurality of tokens that are each selected from a vocabulary of tokens.

4. The method of claim 1, wherein the verification input comprises (i) the current candidate output sequence, (ii) the request, and (iii) a set of one or more verification instructions.

5. The method of claim 1, wherein the adjustment input comprises (i) the current candidate output sequence, (ii) the verification output, and (ii) a set of one or more adjustment instructions.

6. The method of claim 1, wherein selecting, from the plurality of candidate output sequences, the selected candidate output sequence comprises:
randomly selecting a candidate output sequence from the plurality of candidate output sequences as the selected candidate output sequence.

7. The method of claim 1, wherein the operations further comprise:
in response to determining from the verification output that the current candidate output sequence satisfies the one or more output sequence criteria, selecting the current candidate output sequence as the candidate output sequence without updating the current candidate output sequence.

8. The method of claim 1, wherein generating a plurality of candidate output sequences in parallel with each other comprises generating each candidate output sequence on a respective set of one or more hardware devices.

9. A system comprising one or more computers and one or more storage devices storing instructions that, when executed by the one or more computers, cause the one or more computers to perform operations comprising:
receiving a request for an output sequence;
generating a plurality of candidate output sequences in parallel with each other, the generating comprising, for each of the plurality of candidate output sequences:
generating, using a generative neural network, an initial candidate output sequence;
performing the following operations until one or more output sequence criteria are satisfied, wherein the operations comprise:
processing, using the generative neural network, a verification input comprising a current candidate output sequence to generate a verification output that specifies whether the current candidate output sequence satisfies the one or more output sequence criteria; and
in response to determining from the verification output that the current candidate output sequence fails to satisfy the one or more output sequence criteria, updating the current candidate output sequence by processing, using the generative neural network, an adjustment input comprising (i) the current candidate output sequence and (ii) the verification output to generate an adjusted candidate output sequence;
selecting, from the plurality of candidate output sequences, a selected candidate output sequence; and
providing the selected candidate output sequence in response to the request.

10. The system of claim 9, wherein the generative neural network comprises a language model neural network or a multi-modal neural network.

11. The system of claim 9, wherein each candidate output sequence comprises a plurality of tokens that are each selected from a vocabulary of tokens.

12. The system of claim 9, wherein the verification input comprises (i) the current candidate output sequence, (ii) the request, and (iii) a set of one or more verification instructions.

13. The system of claim 9, wherein the adjustment input comprises (i) the current candidate output sequence, (ii) the verification output, and (ii) a set of one or more adjustment instructions.

14. The system of claim 9, wherein selecting, from the plurality of candidate output sequences, the selected candidate output sequence comprises:
randomly selecting a candidate output sequence from the plurality of candidate output sequences as the selected candidate output sequence.

15. The system of claim 9, wherein the operations further comprise:
in response to determining from the verification output that the current candidate output sequence satisfies the one or more output sequence criteria, selecting the current candidate output sequence as the candidate output sequence without updating the current candidate output sequence.

16. The system of claim 9, wherein generating a plurality of candidate output sequences in parallel with each other comprises generating each candidate output sequence on a respective set of one or more hardware devices.

17. One or more non-transitory computer storage media storing instructions that, when executed by one or more computers, cause the one or more computers to perform operations comprising:
receiving a request for an output sequence;
generating a plurality of candidate output sequences in parallel with each other, the generating comprising, for each of the plurality of candidate output sequences:
generating, using a generative neural network, an initial candidate output sequence;
performing the following operations until one or more output sequence criteria are satisfied, wherein the operations comprise:
processing, using the generative neural network, a verification input comprising a current candidate output sequence to generate a verification output that specifies whether the current candidate output sequence satisfies the one or more output sequence criteria; and
in response to determining from the verification output that the current candidate output sequence fails to satisfy the one or more output sequence criteria, updating the current candidate output sequence by processing, using the generative neural network, an adjustment input comprising (i) the current candidate output sequence and (ii) the verification output to generate an adjusted candidate output sequence;
selecting, from the plurality of candidate output sequences, a selected candidate output sequence; and
providing the selected candidate output sequence in response to the request.

18. The computer storage media of claim 17, wherein the generative neural network comprises a language model neural network or a multi-modal neural network.

19. The computer storage media of claim 17, wherein each candidate output sequence comprises a plurality of tokens that are each selected from a vocabulary of tokens.

20. The computer storage media of claim 17, wherein selecting, from the plurality of candidate output sequences, the selected candidate output sequence comprises:
randomly selecting a candidate output sequence from the plurality of candidate output sequences as the selected candidate output sequence.
